(19) United States
(12) Patent Application Publication
(10) Pub. No.: US 2020/0197988 A1
(43) Pub. Date: Jun. 25, 2020

(54) CLEANING DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventor: Teng SHEN, Wuhan, Hubei (CN)

(21) Appl. No.: 16/349,660

(22) PCT Filed: Mar. 19, 2019
(86) PCT No.: PCT/CN2019/078704

§ 371 Date: May 14, 2019

(30) Foreign Application Priority Data
Dec. 10, 2018 (CN) 201811500862.5

(51) Int. Cl. B08B 9/045

(52) U.S. Cl. CPC B08B 9/045

(57) ABSTRACT

A cleaning device is provided. The cleaning device includes a drive rod, at least two cleaning brush heads, and a connection member. The drive rod and the cleaning brush heads are all fixed on the connection member. Fixing points of the cleaning brush heads and the connection member are located at two ends of a mounting point between the drive rod and the connection member.

### FIELD OF INVENTION

The present invention relates to a field of display product manufacturing, especially to a cleaning device.

### BACKGROUND OF INVENTION

During manufacturing of display panels, processes thereof have high environment requirements, for example, a dust-free environment or an environment with better cleanliness. Some dirty holes in circular or rectangular shapes, tunnels or ducts require dust cleaning processes. Conventional cleaning processes are simple, manual cleaning processes.

Manual cleaning has issues of larger labor force and potential safety risks. Furthermore, once a hole is not completely cleaned manually, dust thereon will probably gather and a clean room cannot achieve a dust-free environment, which results in lower product quality. Therefore, a cleaning device to solve the above issue is required urgently.

### SUMMARY OF INVENTION

The present invention provides a cleaning device to solve an issue that cleaning dust in a hole, a tunnel, and a duct is difficult.

To solve the above issue, the present invention provides technical solutions as follows.

A cleaning device is provided and comprises a drive rod, at least two cleaning brush heads and a connection member;

wherein the drive rod and the cleaning brush heads are all fixed on the connection member, and fixing points of the cleaning brush heads and the connection member are located at two ends of a mounting point between the drive rod and the connection member.

In the cleaning device of the present invention, the drive rod is a telescopic rod.

In the cleaning device of the present invention, the drive rod comprises a first rod body and a second rod body, the first rod body and the second rod body are sleeved with each other, and the first rod body and the second rod body are telescopically sleeved with each other.

In the cleaning device of the present invention, the first rod body and the second rod body are hollow.

In the cleaning device of the present invention, the cleaning device comprises two cleaning brush heads, the cleaning brush heads are located two ends of the connection member; and

the connection member comprises a third rod body and a fourth rod body, the third rod body and the fourth rod body are sleeved with each other, and the third rod body and the fourth rod body are telescopically sleeved with each other.

In the cleaning device of the present invention, the cleaning device comprises a lock located on the connection member, when the third rod body and the fourth rod body are sleeved with each other at a targeted length, the lock fixes a position of the third rod body relative to the fourth rod body.

In the cleaning device of the present invention, the cleaning brush heads are roller-shaped, each cleaning brush head comprises a bearing and a cleaning sleeve encompassing a periphery of the bearing.

In the cleaning device of the present invention, the bearing comprises an inner ring, an outer ring and balls disposed between the inner ring and the outer ring;

wherein the inner ring is fixed on the connection member.

In the cleaning device of the present invention, material of the cleaning sleeve comprises one of a cotton material, a dust adhering tape, and a clean soft rubber.

In the cleaning device of the present invention, the drive rod comprises a rod body and a drive unit disposed on the rod body, the drive unit comprises a main rod, a switch, a charging terminal, a power storage member, a drive member and a drive shaft t.

According to another aspect of the present invention, a cleaning device is provided and comprises a drive rod, two cleaning brush heads and a connection member;

the connection member is a telescopic member;

wherein the drive rod and the cleaning brush heads are all fixed on the connection member, and fixing points of the cleaning brush heads and the connection member are located at two ends of a mounting point between the drive rod and the connection member.

In the cleaning device of the present invention, the drive rod is a telescopic rod.

In the cleaning device of the present invention, the drive rod comprises a first rod body and a second rod body, the first rod body and the second rod body are sleeved with each other, and the first rod body and the second rod body are telescopically sleeved with each other.

In the cleaning device of the present invention, the first rod body and the second rod body are hollow.

In the cleaning device of the present invention, the cleaning brush heads are located two ends of the connection member; and

the connection member comprises a third rod body and a fourth rod body, the third rod body and the fourth rod body are sleeved with each other, and the third rod body and the fourth rod body are telescopically sleeved with each other.

In the cleaning device of the present invention, the cleaning device comprises a lock located on the connection member, when the third rod body and the fourth rod body are sleeved with each other at a target length, the lock fixes a position of the third rod body relative to the fourth rod body.

In the cleaning device of the present invention, the cleaning brush heads are roller-shaped, each cleaning brush head comprises a bearing and a cleaning sleeve encompassing a periphery of the bearing.

In the cleaning device of the present invention, the bearing comprises an inner ring, an outer ring and balls disposed between the inner ring and the outer ring;

wherein the inner ring is fixed on the connection member.

In the cleaning device of the present invention, material of the cleaning sleeve comprises one of a cotton material, a dust adhering tape, and a clean soft rubber.

In the cleaning device of the present invention, the drive rod comprises a rod body and a drive unit disposed on the rod body, the drive unit comprises a main rod, a switch, a charging terminal, a power storage member, a drive member and a drive shaft.

Advantages: the present invention, by designing a cleaning device to replace manual dust-cleaning to a hole, a tunnel, and a duct, ensures safety of cleaners and enhances cleaning efficiency.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic structural view of a cleaning device of a first embodiment of the present invention;

FIG. 2 is a schematic structural view of a cleaning device provided by a second embodiment of the present invention;

FIG. 3 is a schematic structural view of a cleaning device provided by a third embodiment of the present invention;

FIG. 4 is a schematic structural view of a cleaning brush head provided by a fourth embodiment of the present invention; and

FIG. 5 is a schematic structural view of a drive rod provided by a fifth embodiment of the present invention.

### DETAILED DESCRIPTION OF PREFERRED EMBODIMENTS

Each of the following embodiments is described with appending figures to illustrate specific embodiments of the present invention that are applicable. The terminologies of direction mentioned in the present invention, such as “upper”, “lower”, “front”, “rear”, “left”, “right”, “inner”, “outer”, “side surface”, etc., only refer to the directions of the appended figures. Therefore, the terminologies of direction are used for explanation and comprehension of the present invention, instead of limiting the present invention. In the figures, units with similar structures are marked with the same reference characters.

The present invention provides a cleaning device to solve an issue that it is difficult to clean dust in a hole, a tunnel, and a duct.

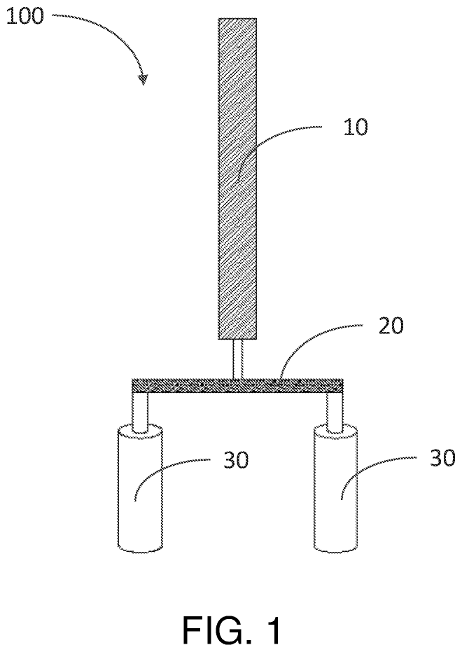

With reference to FIG. 1, FIG. 1 is a schematic structural view of a cleaning device 100 of a first embodiment of the present invention.

The present invention provides a cleaning device 100 comprising a drive rod 10, at least two cleaning brush heads 30, and a connection member 20.

The drive rod 10 and the cleaning brush heads 30 are all fixed on the connection member 20, and fixing points of the cleaning brush heads 30 and the connection member 20 are located at two ends of a mounting point between the drive rod 10 and the connection member 20.

In an embodiment, the cleaning brush heads 30 and the drive rod 10 are located on a side of the connection member 20.

In an embodiment, the cleaning brush heads 30 and the drive rod 10 are located on two sides of the connection member 20 respectively.

During cleaning dust in a hole, a tunnel or a duct, a cleaner can hold the drive rod 10, put the cleaning brush heads 30 into the hole, the tunnel, and the duct, and drive the cleaning brush heads 30 to clean dust off in the hole, the tunnel, and the duct to prevent danger and low efficiency of manual wiping.

In an embodiment, a handle is disposed at an end of the drive rod 10 away from the connection member 20.

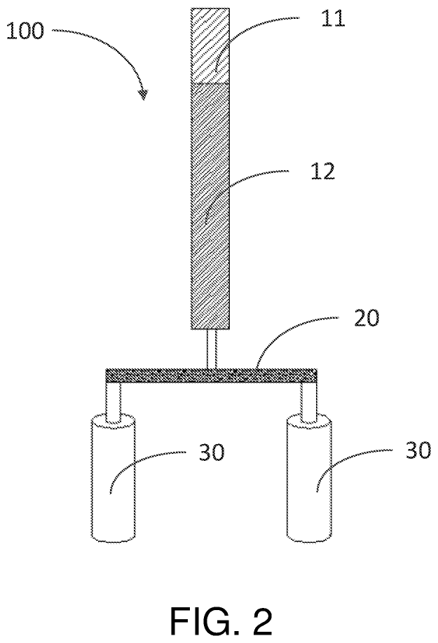

With reference to FIG. 2, FIG. 2 is a schematic structural view of a cleaning device 100 provided by a second embodiment of the present invention.

In an embodiment, the drive rod 10 is a telescopic rod configured to extend and retract to adjust a length of the drive rod 10, which realizes length adjustment of the drive rod 10.

In an embodiment, the drive rod 10 comprises a first rod body 11 and a second rod body 12, the first rod body 11 and the second rod body 12 are sleeved with each other, the first rod body 11 and the second rod body 12 are telescopically sleeved with each other.

In an embodiment, the first rod body 11 and the second rod body 12 are hollow. Such design not only achieves sleeving of the first rod body 11 and the second rod body 12, but also reduces weight of the drive rod 10 and lowers manufacturing cost of the drive rod 10.

In an embodiment, the first rod body 11 contacts the connection member 20, the first rod body 11 is a fixing end, the second rod body 12 is a telescopic end, sleeving conditions of second rod body 12 and the first rod body 11 control a length of the drive rod 10.

In an embodiment, the drive rod 10 comprises a fixing lock. When the first rod body 11 and the second rod body 12 are sleeved with each other at a target length, the fixing lock fixes a position of the first rod body 11 relative to the second rod body 12.

In an embodiment, a surface of the first rod body 11 facing away from the connection member 20 is disposed with a convex thread of a screw bolt, a concave thread is disposed inside the fixing lock. When the second rod body 12 is pulled to a required interval, the fixing lock is rotated to fix the position of the fixing lock to fix the length of the drive rod 10. By telescopic design of the drive rod 10, an occupying area of the drive rod 10 can be decreased to facilitate storage and a higher and deeper hole can be cleaned.

In an embodiment, a maximum interval between the at least two cleaning brush heads is 30 cm.

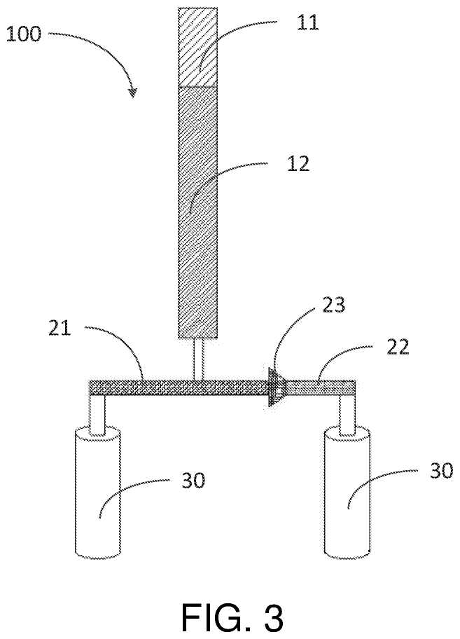

With reference to FIG. 3, FIG. 3 is a schematic structural view of a cleaning device 100 provided by a third embodiment of the present invention.

In an embodiment, the connection member 20 is a telescopic member.

In an embodiment, a number of the cleaning brush heads 30 is two, and the two the cleaning brush heads 30 are located at two ends of the connection member 20 respectively.

In an embodiment, the connection member 20 comprises a third rod body 21 and a fourth rod body 22. The third rod body 21 and the fourth rod body 22 are sleeved with each other. The third rod body 21 and the fourth rod body 22 are telescopically sleeved with each other.

In an embodiment, a lock 23 located on the connection member 20 is included. When the third rod body 21 and the fourth rod body 22 are sleeved with each other at a target length, the lock 23 fixes a position of the third rod body 21 relative to the fourth rod body 22.

In an embodiment, the third rod body 21 is a fixing end, the fourth rod body 22 is a telescopic end, a contacting end of the third rod body 21 with the fourth rod body 22 is disposed with a convex thread of a screw bolt, a concave thread is disposed inside the lock 23. When the fourth rod body 22 is pulled to a required interval, the lock 23 is rotated to fix the position of the lock 23 to fix the length of the connection member 20. By telescopic design of the connection member 20, a hole in any size can be cleaned.

The present invention, by rotation cleaning of the two cleaning brush heads 30, can improve cleaning efficiency of the hole.

In an embodiment, the third rod body 21 is marked with an isometric scale that facilitates acquiring a target length of the connection member 20.

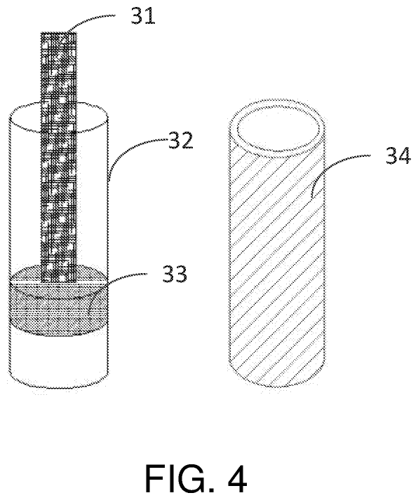

With reference to FIG. 4, FIG. 4 is a schematic structural view of a cleaning brush head 30 provided by a fourth embodiment of the present invention.

In an embodiment, the cleaning brush heads 30 are located at two ends of the connection member 20 respectively.

In an embodiment, the cleaning brush heads 30is roller-shaped, each cleaning brush head 30 comprises a bearing and a cleaning sleeve 34 encompassing a periphery of the bearing.

In an embodiment, the bearing comprises an inner ring 31, an outer ring 32, and balls 33 disposed between the inner ring 31 and the outer ring 32;

wherein the inner ring 31 is fixed on the connection member 20. By design of the bearing of the cleaning brush heads 30, the cleaning sleeve 34 can be rotated smoothly to clean dust off in an area to be cleaned.

In an embodiment, material of the cleaning sleeve 34 comprises a cotton material, the cleaning sleeve 34 made of the cotton material can be disassembled for cleaning.

In an embodiment, material of the cleaning sleeve 34 comprises a dust adhering tape, the dust adhering tape is a structure with loops. Such structure has an advantage that as a transparent adhesive tape, a used loop of the tape can be torn off to prevent replacing the cleaning sleeve 34 for many times.

In an embodiment, material of the cleaning sleeve 34 comprises a detachable soft rubber roller. Compared to the dust adhering tape, the soft rubber roller has an advantage of better cleaning performance and can be replaced at one time.

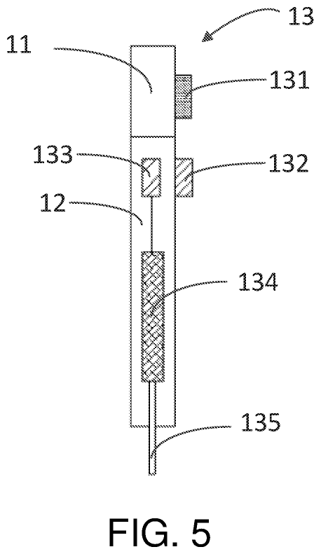

With reference to FIG. 5, FIG. 5 is a schematic structural view of a drive rod 10 provided by a fifth embodiment of the present invention.

In an embodiment, the drive rod 10 comprises a rod body and a drive unit 13 disposed on the rod body. The drive unit 13 comprises a switch 131, a charging terminal 132, a power storage member 133, a drive member 134, and a drive shaft 135.

In an embodiment, the switch 131 and the charging terminal 132 are disposed on an outer wall of the rod body. The power storage member 133 and the drive member 134 are disposed in the rod body. The drive member 134 and the power storage member 133 are connected to the drive shaft 135. The drive shaft 135 is connected to the connection member 20.

Here is an example of the cleaning device 100 with two cleaning brush heads 30. When the cleaning device 100 is used to clean a hole, the connection member 20 can be adjusted to a target length such that the two cleaning brush heads 30 is fitted to a wall of the hole. The switch 131 is opened to make the power storage member 133 to supply power. The drive member 134 rotates and drives the drive shaft 135 to rotate. The drive shaft 135 drives the connection member 20 to rotate such that rotation cleaning of the cleaning brush heads 30 along the wall of the hole is achieved, which has advantages of high efficiency and convenience.

In an embodiment, the specification of the charging terminal 132 can be determined according to the actual situation, and is not limited here.

In an embodiment, the power storage member 133 comprises a power supply.

In an embodiment, the drive member 134 comprises a motor.

The present invention, by the above electric design, can achieve electric cleaning of the cleaning device 100 such that the cleaning device 100 is more labor-saving and convenient. Furthermore, the cleaning device 100 can be used for cyclic charging and has advantages of being environmentally friendly and convenient.

Advantages: the present invention, by designing a cleaning device to replace manual dust-cleaning of a hole, a tunnel, and a duct, ensures cleaners' safety and enhances cleaning efficiency.

Although the preferred embodiments of the present invention have been disclosed as above, the aforementioned preferred embodiments are not used to limit the present invention. The person of ordinary skill in the art may make various changes and modifications without departing from the spirit and scope of the present invention. Therefore, the scope of protection of the present invention is defined by the scope of the claims.

What is claimed is:

1. A cleaning device, comprising a drive rod, at least two cleaning brush heads and a connection member;
wherein the drive rod and the cleaning brush heads are all fixed on the connection member, and fixing points of the cleaning brush heads and the connection member are located at two ends of a mounting point between the drive rod and the connection member.

2. The cleaning device as claimed in claim 1, wherein the drive rod is a telescopic rod.

3. The cleaning device as claimed in claim 2, wherein the drive rod comprises a first rod body and a second rod body, the first rod body and the second rod body are sleeved with each other, and the first rod body and the second rod body are telescopically sleeved with each other.

4. The cleaning device as claimed in claim 3, wherein the first rod body and the second rod body are hollow.

5. The cleaning device as claimed in claim 1, wherein the cleaning device comprises the two cleaning brush heads, the cleaning brush heads are located two ends of the connection member; and
the connection member comprises a third rod body and a fourth rod body, the third rod body and the fourth rod body are sleeved with each other, and the third rod body and the fourth rod body are telescopically sleeved with each other.

6. The cleaning device as claimed in claim 5, wherein the cleaning device comprises a lock located on the connection member, when the third rod body and the fourth rod body are sleeved with each other at a target length, the lock fixes a position of the third rod body relative to the fourth rod body.

7. The cleaning device as claimed in claim 1, wherein the cleaning brush heads are roller-shaped, each cleaning brush head comprises a bearing and a cleaning sleeve encompassing a periphery of the bearing.

8. The cleaning device as claimed in claim 7, wherein the bearing comprises an inner ring, an outer ring, and balls disposed between the inner ring and the outer ring;
wherein the inner ring is fixed on the connection member.

9. The cleaning device as claimed in claim 7, wherein material of the cleaning sleeve comprises one of a cotton material, a dust adhering tape, and a clean soft rubber.

10. The cleaning device as claimed in claim 1, wherein the drive rod comprises a rod body and a drive unit disposed on the rod body, the drive unit comprises a main rod, a switch, a charging terminal, a power storage member, a drive member, and a drive shaft.

11. A cleaning device, comprising a drive rod, two cleaning brush heads, and a connection member;
the connection member is a telescopic member;
wherein the drive rod and the cleaning brush heads are all fixed on the connection member, and fixing points of the cleaning brush heads and the connection member are located at two ends of a mounting point between the drive rod and the connection member.

12. The cleaning device as claimed in claim 11, wherein the drive rod is a telescopic rod.

13. The cleaning device as claimed in claim 12, wherein the drive rod comprises a first rod body and a second rod body, the first rod body and the second rod body are sleeved with each other, and the first rod body and the second rod body are telescopically sleeved with each other.

14. The cleaning device as claimed in claim 13, wherein the first rod body and the second rod body are hollow.

15. The cleaning device as claimed in claim 11, wherein the cleaning brush heads are located two ends of the connection member; and
the connection member comprises a third rod body and a fourth rod body, the third rod body and the fourth rod body are sleeved with each other, and the third rod body and the fourth rod body are telescopically sleeved with each other.

16. The cleaning device as claimed in claim 15, wherein the cleaning device comprises a lock located on the connection member, when the third rod body and the fourth rod body are sleeved with each other at a target length, the lock fixes a position of the third rod body relative to the fourth rod body.

17. The cleaning device as claimed in claim 11, wherein the cleaning brush heads are roller-shaped, each cleaning brush head comprises a bearing and a cleaning sleeve encompassing a periphery of the bearing.

18. The cleaning device as claimed in claim 17, wherein the bearing comprises an inner ring, an outer ring, and balls disposed between the inner ring and the outer ring;
wherein the inner ring is fixed on the connection member.

19. The cleaning device as claimed in claim 17, wherein material of the cleaning sleeve comprises one of a cotton material, a dust adhering tape, and clean soft rubber.

20. The cleaning device as claimed in claim 11, wherein the drive rod comprises a rod body and a drive unit disposed on the rod body, the drive unit comprises a main rod, a switch, a charging terminal, a power storage member, a drive member, and a drive shaft.
